(19) United States
(12) Patent Application Publication
(10) Pub. No.: US 2006/0294027 A1
(43) Pub. Date: Dec. 28, 2006

(54) Multiplex assay pricing system

(76) Inventors: Maneesh Jain, San Francisco, CA (US); Mason Clark, Belmont, CA (US)

Correspondence Address: Chief Intellectual Property Counsel;Affymetrix, Inc., 3420 Central Expressway, Santa Clara, CA, 95051, US

(21) Appl. No.: 11/168,972

(22) Filed: Jun. 28, 2005

(51) Int. Cl. G06F 17/00

(52) U.S. Cl. 705/400

(57) ABSTRACT

The invention provides a system for pricing multiplex assay products that have a manufacturing cost that is substantially the same over a wide range of multiplex levels. Typically, manufacturing costs of such a product increase only linearly with exponential increases in multiplex levels. The pricing system and method of the invention permits a vendor to access a larger market by charging lower prices to customers requiring only low amounts of data from a multiplex assay product or data delivered over time or conditioned on results or interpretation of earlier purchased data points.

### FIELD OF THE INVENTION

The present invention relates to a system and methods for determining prices for multiplex assay products, and more particularly, for determining price based on assay information requested by a customer.

### BACKGROUND

The quantity of biological information available to researchers in the fields of DNA, RNA and protein analysis continues to grow exponentially. This is being driven by the explosive growth in public and private repositories of biological data and the rapid advances in technology for highly multiplexed assays. These advances have enabled large scale projects in the biological and medical sciences for studying a wide range of biological phenomena, e.g. gene expression patterns in states of health and disease, genomic and genetic variability in cancer, genetic basis of disease susceptibilities or the manifestation of other complex traits, such as individual responsiveness to therapeutics, and the like. These projects are being carried out both by academic institutions and by the pharmaceutical and biotechnology industries using specialized products and instruments that permit highly multiplexed measurements on samples from humans, animals, plants, and other biological organisms.

Microarrays are key components of many multiplex assays that have played a central role in enabling such large-scale projects, e.g. Hacia et al, Nature Genetics, 21: 42-47 (1999); Golub et al, Science, 286: 531-537 (1999); Alizadeh et al, Nature, 403: 503-511 (2000); Perou et al, Nature, 406: 747-752 (2000); Chee et al, Science, 274: 610-614 (1996); Kennedy et al, Nature Biotechnology, 21: 1233-1237 (2003); Hinds et al, Science, 307: 1072-1079 (2005); and the like. DNA-based microarrays, or “DNA chips,” typically comprise a solid phase support having a planar surface, which carries an array of nucleic acids, each member of the array having identical copies of an oligonucleotide or polynucleotide immobilized at a spatially defmed region or site, which does not overlap with those of other members of the array. The sites are densely packed, with up to many thousands of sites per cm², and each site has the potential of providing information about the presence, absence, or the quantity of an analyte in a sample being assayed. Such miniaturization permits very complex mixtures of probes or targets to be analyzed with very little reagent usage. Microarrays are manufactured by a variety of approaches, including use of photo-sensitive masks and synthesis chemistries, e.g. Fodor et al, U.S. Pat. Nos. 5,424,186; 5,744,305; 5,445,934; 6,355,432; 6,440,667 (Affymetrix, Santa Clara, Calif.); Cerrina et al, U.S. Pat. No. 6,375,903 (NimbleGen, Madison, Wis.); use of “ink-jet” technology, e.g. disclosed in Hughes et al, Nature Biotechnology, 19: 342-347 (2001); Caren et al U.S. Pat. No. 6,323,043 (Agilent Technologies, Palo Alto, Calif.); deposition or “spotting” of fully synthesized sequences, e.g. Schena, Editor, Microarrays: A Practical Approach (IRL Press, Oxford, 2000); Fung, Protein Arrays: Methods and Protocols (Humana Press, 2004); and the like.

The coincidence of two sets of circumstances has led to difficulties in setting appropriate prices on the microarray products described above. First, the multiplex level of a microarray, i.e. the total number of discrete sites with oligonucleotides attached, has only a minor effect of cost of production. Thus, a microarray product often costs the same, or nearly the same, over a wide range of different multiplex levels. For example, the original-equipment-manufacturing (OEM) cost of a 1000-site microarray is nearly the same as that of a 100,000-site microarray. Second, the current market for such products is highly fragmented both in terms of annual budgets of purchasing entities ($50,000-$500,000) and in the relative scientific value assigned to the number of analytes assayed per microarray. Prices that vary from $0.002 per analyte to $0.02 per analyte are not uncommon. As a result, a medium-capacity microarray, e.g. having 10,000-sites for genotyping common human polymorphisms, may be sold for a discrete price that will, on the one hand, fail to fit the budgets of smaller users who want to run fewer assays and, on the other hand, be too low for users who have a unique requirement for measuring thousands analytes that can only be satisfied by highly multiplexed technology, such as a microarray-based assay.

In view of the above, it would be advantageous if a pricing system were available for multiplexed-assay products, such as microarrays, that would provide a better balance between making such products available to small-scale users with restricted budgets and obtaining the benefit of providing a unique cost-saving tool for large-scale users.

### SUMMARY OF THE INVENTION

The invention provides a system for pricing multiplex assay products that have a manufacturing cost that is substantially the same over a wide range of multiplex levels. Typically, manufacturing costs of such a product increase only linearly with exponential increases in multiplex levels. The pricing system and method of the invention permits a vendor to access a larger market by charging lower prices customers requiring only low amounts of data from a multiplex assay product or data delivered over time or conditioned on results or interpretation of earlier purchased data points. In one aspect, the method of the invention is carried out with the following steps: (i) a database storing probe address data for each multiplex assay product, the probe address data including information that associates each predetermined analyte with an address of a probe site on the multiplex assay product; (ii) a database storing analyte selection information of a customer, the analyte selection information including information identifying a customer-determined subset of the predetermined analytes on each multiplex assay product purchased by the customer and a confirmation of payment, the customer-determined subset having a size and content, and the payment comprising a base fee and a use fee that is a function of the size and content of the customer-determined subset; (iii) a request for data transmitted by a customer; and (iv) a billing analysis system receiving the request for data, accessing the database storing probe address data for the customer's multiplex assay product, accessing the database storing customer's analyte selection information, validating that customer is authorized to receive requested data, and transmitting to customer requested data for customer's analyte selection, the requested data including probe address data for probe sites of the customer-determined subset of predetermined analytes.

In another aspect, the invention includes a method of providing a customer with genetic data generated by a multiplex assay product, the method comprising the steps of: (a) selling a multiplex assay product by a vendor to a customer for a base price; (b) transmitting to the customer a quality control measure in response to the customer (i) performing a multiplex assay that uses the multiplex assay product, and (ii) transmitting raw data therefrom to the vendor; (c) receiving from the customer a request for data if the quality control measure satisfies a predetermined criterion of the customer, the request for data having an amount of data; (d) generating a price for the request for data, the price being a monotonic function of the amount of data; (e) validating that customer is authorized to receive data; and (f) transmitting data to the customer.

The variable pricing system and method of the invention provides an expanded market for vendors of multiplex assay products by making such products accessible to customers with budget and purchasing constraints. The system and method also provides advantages to high capacity customers, such as core genome centers, and the like, by providing the flexibility of pricing schemes that allow discounting over multiple products.

### BRIEF DESCRIPTION OF THE FIGURES

FIGS. 1A-1F illustrate features and benefits of the pricing system of the invention.

FIG. 2A is a flow chart for implementing one aspect of the invention.

FIG. 2B diagrammatically illustrates components of a system for implementing an embodiment of the invention.

FIG. 3 illustrates a type of probe for use with a multiplex assay product that together may be priced in accordance with the invention.

### DEFINITIONS

Terms and symbols of nucleic acid chemistry, biochemistry, genetics, and molecular biology used herein follow those of standard treatises and texts in the field, e.g. Komberg and Baker, DNA Replication, Second Edition (W.H. Freeman, New York, 1992); Lehninger, Biochemistry, Second Edition (Worth Publishers, New York, 1975); Strachan and Read, Human Molecular Genetics, Second Edition (Wiley-Liss, New York, 1999); Eckstein, editor, Oligonucleotides and Analogs: A Practical Approach (Oxford University Press, New York, 1991); Gait, editor, Oligonucleotide Synthesis: A Practical Approach (IRL Press, Oxford, 1984); and the like.

“Addressable” in reference to a multiplex assay product means that the identity of a probe, e.g. an oligonucleotide tag, or tag complement, protein, peptide, antibody, or the like, can be determined from a spatial location on, or characteristic of, a solid phase support to which it is attached. In one aspect, an address of a probe is a spatial location, e.g. the planar coordinates of a particular region containing copies of the probe. In other embodiments, probes may be addressed in other ways, e.g. by microparticle size, shape, color, color- or fluorescent ratio, radio frequency of micro-transponder, or the like, e.g. Kettman et al, Cytometry, 33: 234-243 (1998); Xu et al, Nucleic Acids Research, 31: e43 (2003); Bruchez, Jr. et al, U.S. Pat. No. 6,500,622; Mandecki, U.S. Pat. No. 6,376,187; Stuelpnagel et al, U.S. Pat. No. 6,396,995; Chee et al, U.S. Pat. No. 6,544,732; Chandler et al, PCT publication WO 97/14028; and the like.

“Amplicon” means the product of a polynucleotide amplification reaction. That is, it is a population of polynucleotides, usually double stranded, that are replicated from one or more starting sequences. The one or more starting sequences may be one or more copies of the same sequence, or it may be a mixture of different sequences. Amplicons may be produced by a variety of amplification reactions whose products are multiple replicates of one or more target nucleic acids. Generally, amplification reactions producing amplicons are “template-driven” in that base pairing of reactants, either nucleotides or oligonucleotides, have complements in a template polynucleotide that are required for the creation of reaction products. In one aspect, template-driven reactions are primer extensions with a nucleic acid polymerase or oligonucleotide ligations with a nucleic acid ligase. Such reactions include, but are not limited to, polymerase chain reactions (PCRs), linear polymerase reactions, nucleic acid sequence-based amplification (NASBAs), rolling circle amplifications, and the like, disclosed in the following references that are incorporated herein by reference: Mullis et al, U.S. Pat. Nos. 4,683,195; 4,965,188; 4,683,202; 4,800,159 (PCR); Gelfand et al, U.S. Pat. No. 5,210,015 (real-time PCR with “taqman” probes); Wittwer et al, U.S. Pat. No. 6,174,670; Kacian et al, U.S. Pat. No. 5,399,491 (“NASBA”); Lizardi, U.S. Pat. No. 5,854,033; Aono et al, Japanese patent publ. JP 4-262799 (rolling circle amplification); and the like. In one aspect, amplicons of the invention are produced by PCRs. An amplification reaction may be a “real-time” amplification if a detection chemistry is available that permits a reaction product to be measured as the amplification reaction progresses, e.g. “real-time PCR” described below, or “real-time NASBA” as described in Leone et al, Nucleic Acids Research, 26: 2150-2155 (1998), and like references. As used herein, the term “amplifying” means performing an amplification reaction. A “reaction mixture” means a solution containing all the necessary reactants for performing a reaction, which may include, but not be limited to, buffering agents to maintain pH at a selected level during a reaction, salts, co-factors, scavengers, and the like.

“Analyte” means a substance, compound, or component in a sample whose presence or absence is to be detected or whose quantity is to be measured in an assay. Analytes include but are not limited to peptides, proteins, polynucleotides, polypeptides, oligonucleotides, genomic fragments, organic molecules, haptens, epitopes, parts of biological cells, posttranslational modifications of proteins, receptors, complex sugars, vitamins, hormones, and the like. There may be more than one analyte associated with a single molecular entity, e.g. different phosphorylation sites on the same protein, or different loci on a single polynucleotide.

“Complementary or substantially complementary” refers to the hybridization or base pairing or the formation of a duplex between nucleotides or nucleic acids, such as, for instance, between the two strands of a double stranded DNA molecule or between an oligonucleotide primer and a primer binding site on a single stranded nucleic acid. Complementary nucleotides are, generally, A and T (or A and U), or C and G. Two single stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

“Compexity” in reference to mixtures of nucleic acids means the total length of unique sequences in the mixture. In reference to genomic DNA, complexity means the total length of unique sequence DNA in a genome. The complexity of a genome can be equivalent to or less than the length of a single copy of the genome (i.e. the haploid sequence). Estimates of genome complexity can be less than the total length if adjusted for the presence of repeated sequences. In other words, in reference to genomic DNA, “complexity” means the total number of basepairs present in non-repeating sequences, e.g. Wetmur, Critical Reviews in Biochemistry and Molecular Biology, 26: 227-259 (1991); Britten and Davidson, chapter 1 in Hames et al, editors, Nucleic Acid Hybridization: A Practical Approach (IRL Press, Oxford, 1985).

“Computer-readable product” means any tangible medium for storing information that can be read by or transmitted into a computer. Computer-readable products include, but are not limited to, magnetic diskettes, magnetic tapes, optical disks, CD-ROMs, punched tape or cards, read-only memory devices, direct access storage devices, gate arrays, electrostatic memory, and any other like medium.

“Data point” means a unit of information that is derived from one or more signals collected from each of one or more probe sites, or features, of a multiplex assay product. In one aspect, the number of data points generated from a multiplex assay product is directly related to the number of probe sites, or features, of the multiplex assay product. In another aspect, a data point corresponds to signals collected from 1 to 50 probe sites; in still another aspect, a data point corresponds to signals collected from 1 to 30 probe sites; and in still another aspect, a data point corresponds to signals collected from 1 to 20 probe sites. Exemplary signals include fluorescence intensity, fluorescence lifetime, color, chemilumenscence intensity, and the like. In one aspect, a data point corresponds to such biological measures as gene expression level, genotype, protein expression level, or the like.

“Duplex” means at least two oligonucleotides and/or polynucleotides that are fully or partially complementary undergo Watson-Crick type base pairing among all or most of their nucleotides so that a stable complex is formed. The terms “annealing” and “hybridization” are used interchangeably to mean the formation of a stable duplex. In one aspect, stable duplex means that a duplex structure is not destroyed by a stringent wash, e.g. conditions including temperature of about 5° C. less that the Tₘ of a strand of the duplex and low monovalent salt concentration, e.g. less than 0.2 M, or less than 0.1 M. “Perfectly matched” in reference to a duplex means that the poly- or oligonucleotide strands making up the duplex form a double stranded structure with one another such that every nucleotide in each strand undergoes Watson-Crick basepairing with a nucleotide in the other strand. The term “duplex” comprehends the pairing of nucleoside analogs, such as deoxyinosine, nucleosides with 2-aminopurine bases, PNAs, and the like, that may be employed. A “mismatch” in a duplex between two oligonucleotides or polynucleotides means that a pair of nucleotides in the duplex fails to undergo Watson-Crick bonding.

“Genetic locus,” or “locus” in reference to a genome or target polynucleotide, means a contiguous subregion or segment of the genome or target polynucleotide. As used herein, genetic locus, or locus, may refer to the position of a nucleotide, a gene, or a portion of a gene in a genome, including mitochondrial DNA, or it may refer to any contiguous portion of genomic sequence whether or not it is within, or associated with, a gene. In one aspect, a genetic locus refers to any portion of genomic sequence, including mitochondrial DNA, from a single nucleotide to a segment of few hundred nucleotides, e.g. 100-300, in length. Usually, a particular genetic locus may be identified by its nucleotide sequence, or the nucleotide sequence, or sequences, of one or both adjacent or flanking regions.

“Hybridization-based assay” means any assay that relies on the formation of a stable duplex or triplex between a probe and a target nucleotide sequence for detecting or measuring such a sequence. In one aspect, probes of such assays anneal to (or form duplexes with) regions of target sequences in the range of from 8 to 100 nucleotides; or in other aspects, they anneal to target sequences in the range of from 8 to 40 nucleotides, or more usually, in the range of from 8 to 20 nucleotides. A “probe” in reference to a hybridization-based assay mean a polynucleotide that has a sequence that is capable of forming a stable hybrid (or triplex) with its complement in a target nucleic acid and that is capable of being detected, either directly or indirectly. Hybridization-based assays include, without limitation, assays based on use of oligonucleotides, such as polymerase chain reactions, NASBA reactions, oligonucleotide ligation reactions, single-base extensions of primers, circularizable probe reactions, allele-specific oligonucleotides hybridizations, either in solution phase or bound to solid phase supports, such as microarrays or microbeads. There is extensive guidance in the literature on hybridization-based assays, e.g. Hames et al, editors, Nucleic Acid Hybridization a Practical Approach (IRL Press, Oxford, 1985); Tijssen, Hybridization with Nucleic Acid Probes, Parts I & II (Elsevier Publishing Company, 1993); Hardiman, Microarray Methods and Applications (DNA Press, 2003); Schena, editor, DNA Microarrays a Practical Approach (IRL Press, Oxford, 1999); and the like. In one aspect, hybridization-based assays are solution phase assays; that is, both probes and target sequences hybridize under conditions that are substantially free of surface effects or influences on reaction rate. A solution phase assay may include circumstance where either probes or target sequences are attached to microbeads.

“Microarray” refers to a type of multiplex assay product that comprises a solid phase support having a substantially planar surface on which there is an array of spatially defmed non-overlapping regions or sites that each contain an immobilized probe. “Substantially planar” means that features or objects of interest, such as probe sites, on a surface may occupy a volume that extends above or below a surface and whose dimensions are small relative to the dimensions of the surface. For example, beads disposed on the face of a fiber optic bundle create a substantially planar surface of probe sites, or oligonucleotides disposed or synthesized on a porous planar substrate creates a substantially planar surface. Spatially defmed sites may additionally be “addressable” in that its location and the identity of the immobilized probe at that location are known or determinable. Probes immobilized on microarrays include nucleic acids, peptides, proteins, sugars, and other compounds that are capable of specifically binding to an analyte, or to a reagent, such as an oligonucleotide tag, that is generated in or from an assay reaction. In one aspect, probes of microarrays are peptides or protein, in which case, such microarrays are sometimes referred to as peptide chips or protein chips, respectively. In another aspect, probes of microarrays are oligonucleotides or polynucleotides, in which case, such microarrays are sometimes referred to as DNA chips. Typically, the oligonucleotides or polynucleotides on microarrays are single stranded and are covalently attached to the solid phase support, usually by a 5′-end or a 3′-end. The density of non-overlapping regions containing nucleic acids in a microarray is typically greater than 100 per cm², and more preferably, greater than 1000 per cm². Microarray technology relating to nucleic acid probes is reviewed in the following exemplary references: Schena, Editor, Microarrays: A Practical Approach (IRL Press, Oxford, 2000); Southern, Current Opin. Chem. Biol., 2: 404-410 (1998); Nature Genetics Supplement, 21: 1-60 (1999); and Fodor et al, U.S. Pat. Nos. 5,424,186; 5,445,934; and 5,744,305. Microarray may comprise arrays of microbeads, or other microparticles, disposed on a planar surface. Such microarrays may be formed in a variety of ways, as disclosed in the following exemplary references: Brenner et al, Nature Biotechnology, 18: 630-634 (2000); Tulley et al, U.S. Pat. No. 6,133,043; Stuelpnagel et al, U.S. Pat. No. 6,396,995; Chee et al, U.S. Pat. No. 6,544,732; and the like.

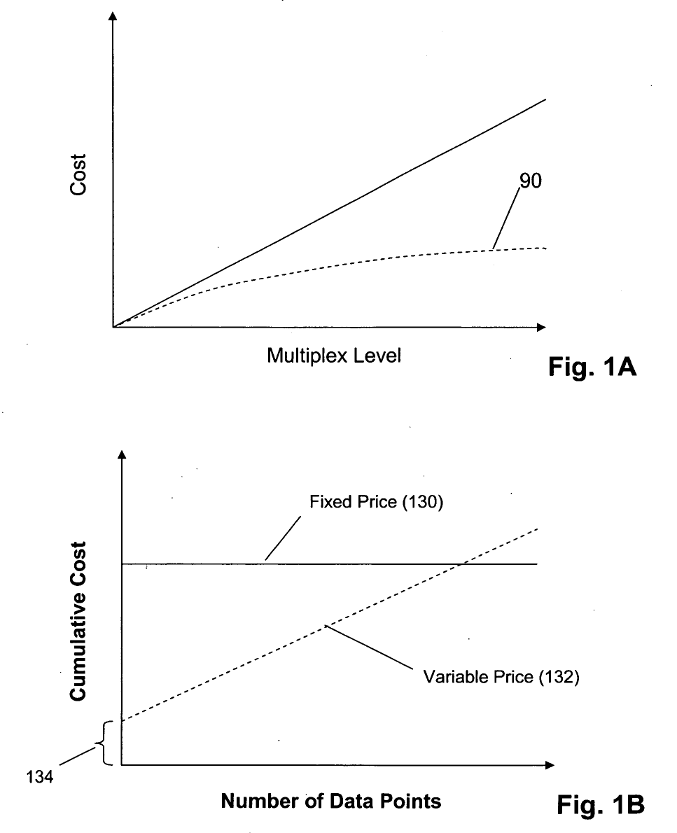

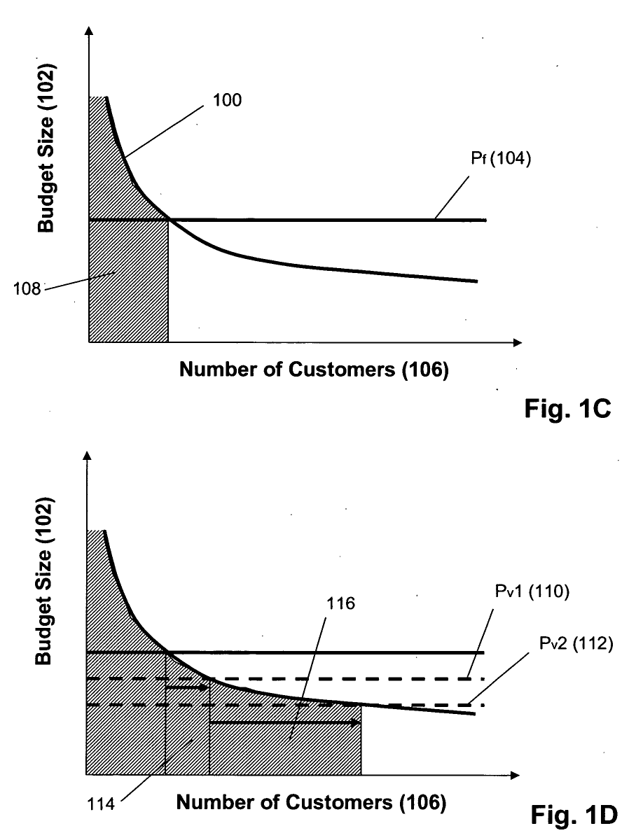

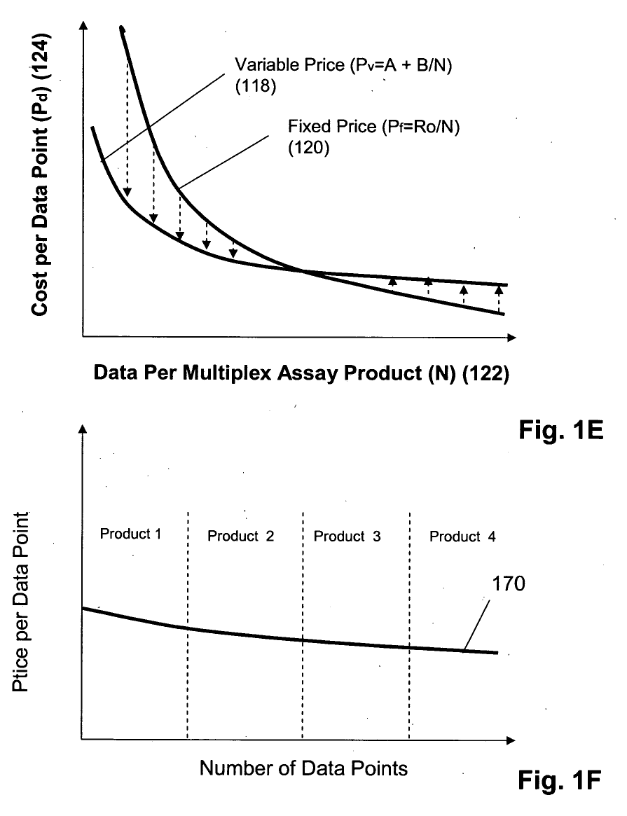

“Multiplex assay product” means a product that is a component of a multiplex assay for simultaneously detecting or measuring a plurality of analytes, wherein the cost of such product is substantially independent of multiplex level. In one aspect, the multiplex level of a multiplex assay product increases exponentially for linear increases in cost. In one aspect, a multiplex assay product is one or more solid phase supports that contain, either alone or collectively, multiple volumes or surface areas each containing a probe, or other substance, whose properties are detectably changed as a result of an assay. Such volumes or surface areas are also referred to herein as “probe sites,” or “sites,” or “features.” Usually, there is a direct relationship between the number of probe sites of a multiplex assay product and the number of data points that are generated. In one aspect, such volumes or surface areas have dimensions in the sub-micron range, e.g. their largest dimension being less than 1 μm, and thus are not readily observable with the naked eye. In another aspect, the cost of production of a multiplex assay product is substantially the same for a wide range of multiplex levels, as illustrated in FIG. 1A. Curve (90) of FIG. 1A illustrates the cost of production of a typical multiplex assay product as a function of multiplex level. Curve (90) describes a circumstance in which marginal increases in multiplex level are achieved at progressively lower and lower costs. In one aspect, a 3-fold increase in multiplex level of a multiplex assay product comes at less than a 2-fold increase in manufacturing cost; in another aspect, a 4-fold increase in multiplex level of a multiplex assay product comes at less than a 2-fold increase in manufacturing cost; in another aspect, a 5-fold increase in multiplex level of a multiplex assay product comes at less than a 2-fold increase in manufacturing cost; in another aspect, a 10-fold increase in multiplex level of a multiplex assay product comes at less than a 2-fold increase in manufacturing cost; in another aspect, a 100-fold increase in multiplex level of a multiplex assay product comes at less than a 2-fold increase in manufacturing cost; in another aspect, a 1000-fold increase in multiplex level of a multiplex assay product comes at less than a 2-fold increase in manufacturing cost; in another aspect, a 10,000-fold increase in multiplex level of a multiplex assay product comes at less than a 2-fold increase in manufacturing cost. In one aspect, the cost of a multiplex assay product varies no more than two fold between a product having 1000 sites, or features, and a product having 50,000,000 sites, or features. In another aspect, the cost of a multiplex assay product varies no more than two fold between a product having 10,000 sites, or features, and a product having 5,000,000 sites, or features. In another aspect, the cost of a multiplex assay product varies no more than two fold between a product having 10,000 sites, or features, and a product having 1,000,000 sites, or features. In another aspect, the cost of a multiplex assay product varies no more than two fold between a product having 30,000 sites, or features, and a product having 1,000,000 sites, or features. In another aspect, the cost of a multiplex assay product varies no more than two fold between a product having 10,000 sites, or features, and a product having 100,000 sites, or features. In another aspect, a multiplex assay product is a microarray, such as a DNA chip or protein chip. In another aspect, a multiplex assay product is a collection of addressable microbeads or microparticles. Such microbeads or microparticles may be addressed or identified by a variety of techniques, including shape, optical signals, radio frequency tags, conductivity, and the like, e.g. Kettman et al, Cytometry, 33: 234-243 (1998); Xu et al, Nucleic Acids Research, 31: e43 (2003); Bruchez, Jr. et al, U.S. Pat. No. 6,500,622; Mandecki, U.S. Pat. No. 6,376,187; Stuelpnagel et al, U.S. Pat. No. 6,396,995; Chee et al, U.S. Pat. No. 6,544,732; and the like. In still another aspect, a multiplex assay product can be a multiplex probe, such as a multiplex hybridization probe (as exemplified by molecular inversion probes described below), particularly when such probes are made using another multiplex assay product, for example, by synthesizing oligonucleotide on a microarray.

“Polymorphism” or “genetic variant” means a substitution, inversion, insertion, or deletion of one or more nucleotides at a genetic locus, or a translocation of DNA from one genetic locus to another genetic locus. In one aspect, polymorphism means one of multiple alternative nucleotide sequences that may be present at a genetic locus of an individual and that may comprise a nucleotide substitution, insertion, or deletion with respect to other sequences at the same locus in the same individual, or other individuals within a population. An individual may be homozygous or heterozygous at a genetic locus; that is, an individual may have the same nucleotide sequence in both alleles, or have a different nucleotide sequence in each allele, respectively. In one aspect, insertions or deletions at a genetic locus comprises the addition or the absence of from 1 to 10 nucleotides at such locus, in comparison with the same locus in another individual of a population (or another allele in the same individual). Usually, insertions or deletions are with respect to a major allele at a locus within a population, e.g. an allele present in a population at a frequency of fifty percent or greater.

“Polynucleotide” or “oligonucleotide” are used interchangeably and each mean a linear polymer of nucleotide monomers. Monomers making up polynucleotides and oligonucleotides are capable of specifically binding to a natural polynucleotide by way of a regular pattern of monomer-to-monomer interactions, such as Watson-Crick type of base pairing, base stacking, Hoogsteen or reverse Hoogsteen types of base pairing, or the like. Such monomers and their internucleosidic linkages may be naturally occurring or may be analogs thereof, e.g. naturally occurring or non-naturally occurring analogs. Non-naturally occurring analogs may include PNAs, phosphorothioate internucleosidic linkages, bases containing linking groups permitting the attachment of labels, such as fluorophores, or haptens, and the like. Whenever the use of an oligonucleotide or polynucleotide requires enzymatic processing, such as extension by a polymerase, ligation by a ligase, or the like, one of ordinary skill would understand that oligonucleotides or polynucleotides in those instances would not contain certain analogs of internucleosidic linkages, sugar moities, or bases at any or some positions. Polynucleotides typically range in size from a few monomeric units, e.g. 5-40, when they are usually referred to as “oligonucleotides,” to several thousand monomeric units. Whenever a polynucleotide or oligonucleotide is represented by a sequence of letters (upper or lower case), such as “ATGCCTG,” it will be understood that the nucleotides are in 5′→3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999). Usually polynucleotides comprise the four natural nucleosides (e.g. deoxyadenosine, deoxycytidine, deoxyguanosine, deoxythymidine for DNA or their ribose counterparts for RNA) linked by phosphodiester linkages; however, they may also comprise non-natural nucleotide analogs, e.g. including modified bases, sugars, or internucleosidic linkages. It is clear to those skilled in the art that where an enzyme has specific oligonucleotide or polynucleotide substrate requirements for activity, e.g. single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al, Molecular Cloning, Second Edition (Cold Spring Harbor Laboratory, New York, 1989), and like references.

“Pricing” means a method, algorithm, or function for determining a price to be charged a customer for a requested service. In one aspect, pricing refers to a method, algorithm, or function for determining the price to be charged a customer for a request for data, wherein such price depends on factors including, but not limited to, the nature of the assay performed, the identity of the analyte for which data is requested, how much data has already been delivered to a customer from the same assay, and the like.

“Primer” means an oligonucleotide, either natural or synthetic, that is capable, upon forming a duplex with a polynucleotide template, of acting as a point of initiation of nucleic acid synthesis and being extended from its 3′ end along the template so that an extended duplex is formed. The sequence of nucleotides added during the extension process are determined by the sequence of the template polynucleotide. Usually primers are extended by a DNA polymerase. Primers usually have a length in the range of from 14 to 36 nucleotides.

“Readout” means a parameter, or parameters, which are measured and/or detected that can be converted to a number or value. In some contexts, readout may refer to an actual numerical representation of such collected or recorded data. For example, a readout of fluorescent intensity signals from a microarray is the address and fluorescence intensity of a signal being generated at each hybridization site of the microarray; thus, such a readout may be registered or stored in various ways, for example, as an image of the microarray, as a table of numbers, or the like.

“Solid support”, “support”, and “solid phase support” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. Microarrays usually comprise at least one planar solid phase support, such as a glass microscope slide.

“Specific” or “specificity” in reference to the binding of one molecule to another molecule, such as a labeled target sequence for a probe, means the recognition, contact, and formation of a stable complex between the two molecules, together with substantially less recognition, contact, or complex formation of that molecule with other molecules. In one aspect, “specific” in reference to the binding of a first molecule to a second molecule means that to the extent the first molecule recognizes and forms a complex with another molecules in a reaction or sample, it forms the largest number of the complexes with the second molecule. Preferably, this largest number is at least fifty percent. Generally, molecules involved in a specific binding event have areas on their surfaces or in cavities giving rise to specific recognition between the molecules binding to each other. Examples of specific binding include antibody-antigen interactions, enzyme-substrate interactions, formation of duplexes or triplexes among polynucleotides and/or oligonucleotides, receptor-ligand interactions, and the like. As used herein, “contact” in reference to specificity or specific binding means two molecules are close enough that weak non-covalent chemical interactions, such as Van der Waal forces, hydrogen bonding, base-stacking interactions, ionic and hydrophobic interactions, and the like, dominate the interaction of the molecules.

“Sample” means a quantity of material from a biological, environmental, medical, or patient source in which detection or measurement of target nucleic acids is sought. On the one hand it is meant to include a specimen or culture (e.g., microbiological cultures). On the other hand, it is meant to include both biological and environmental samples. A sample may include a specimen of synthetic origin. Biological samples may be animal, including human, fluid, solid (e.g., stool) or tissue, as well as liquid and solid food and feed products and ingredients such as dairy items, vegetables, meat and meat by-products, and waste. Biological samples may include materials taken from a patient including, but not limited to cultures, blood, saliva, cerebral spinal fluid, pleural fluid, milk, lymph, sputum, semen, needle aspirates, and the like. Biological samples may be obtained from all of the various families of domestic animals, as well as feral or wild animals, including, but not limited to, such animals as ungulates, bear, fish, rodents, etc. Environmental samples include environmental material such as surface matter, soil, water and industrial samples, as well as samples obtained from food and dairy processing instruments, apparatus, equipment, utensils, disposable and non-disposable items. These examples are not to be construed as limiting the sample types applicable to the present invention.

### DETAILED DESCRIPTION OF THE INVENTION

Most multiplex assay products generate results that are inherently encrypted in the sense that detection and data analysis systems are required to convert collected signals, for example optical signals, such as fluorescence intensities, or the like, to raw data, and finally to processed data, from which useful information can be more readily extracted. This occurs because the reactions that generate signals usually take place in volumes or on surfaces that have sub-micron dimensions, or the signals generated in such reactions are not directly observable by human senses, e.g. infrared or radio signals. Raw data is typically a set of numerical values that may be expressed as a function of time or a spatial parameter, for example, an x-y location on a planar array, a pixel location in a charged-coupled device (CCD) detector, or the like. In a large number of hybridization-based assays, raw data comprises optical intensities collected over a two- or three-dimensional surface, such as a microarray surface or a collection of beads disposed on a surface. For many multiplex assay products, raw data is encrypted not only by virtue of the nature of the generated signals, as described above, but also by the use of oligonucleotide tags in a signal-generation process, wherein the assignment of a particular oligonucleotide tag to a particular analyte or reaction is an arbitrary design choice; that is, any tag may be associated with any reaction. In other words, the oligonucleotide tags are interchangeable. Consequently, if the function of an oligonucleotide tag is primarily a means of shuttling a label to a site on a microarray, or other readout platform, then the selection of oligonucleotide tags may be used as a means for encrypting the location of a signal corresponding to a given analyte on a readout platform. A signal relating to a desired analyte may be identified by a knowledge of which analytes are associated with which oligonucleotide tags. This information, in turn, gives the location on the readout platform of the desired signal. In one aspect of the invention, the selection of correspondence between the oligonucleotide tags and the addresses of their respective tag complements is used to encrypt raw data from a multiplex assay.

The encryption of raw data, whether inherent or otherwise, permits multiplex assay products to be priced according to information that is extracted from them. In particular, because such a product costs substantially the same whether it is capable of producing a few or many thousands of data points, it may be sold at a variable price in accordance with the invention. Two pricing schemes are illustrated in FIG. 1B that shows the relationship between cumulative cost of data points and the number of data points desired or obtained by a customer. Under one scheme, a multiplex assay product has a fixed price (130) regardless of the number of data point desire. Thus, a customer pays for receiving all data points whether required or not. Thus, as discussed more fully below, the price from data point actually used by a customer is a simple inverse function of the number of data points, e.g. R₀/N, where R₀ is fixed price (130) and N is the number of data points. Under a variable pricing (132) scheme, a multiplex assay product is purchased for an initial base price (134) plus a variable amount depending on the number of data points desired. The advantage of the latter scheme is that for manufacturers of multiplex assay products, it expands the market of potential customers, since customers needing only a few data points need not pay for more his or her requirements. Typically, but not necessarily, base price (134) is equal to or close to the cost of the multiplex assay product. In some pricing embodiments, base price (134) may actually be less than cost for some market segments where a vendor is reasonably certain that eventual data purchases would cover costs. Finally, the variable pricing scheme may be selected so that a customer may actually pay more than the fixed price amount, if enough data points are eventually used, as illustrated by the intersection of line (132) with line (130) of FIG. 1B.

The expansion or increase in market size brought about by the pricing scheme of the invention is illustrated in FIGS. 1C-E. In the chart of FIG. 1C, curve (100) illustrates the relationship between budget size (102) of a customer and the number of customers (106) having that budget size. As illustrated, typically there will be a few customers with very large budgets that can readily afford the full fixed price P_{f}(104) of a multiplex assay product, e.g. core facilities at hospitals, government laboratories, and academic institutions, and many customers with small budgets that cannot afford the full fixed price P_{f}(104), e.g. individual academic laboratories, small biotechnology firms, and the like. Under these circumstances, the market is represented by shaded area (108). Under a variable pricing scheme of the invention, illustrated in FIG. 1D, as the price of the multiplex assay product is reduced (shown as Pᵥ₁ (110) and Pᵥ₂ (112)) the market size is increase as illustrated by the successive increases (114) and (116) in shaded area under curve (100).

The same phenomena is illustrated in a different way in FIG. 1E by curves (118) and (120), which illustrate relationships between cost per data point Pd (124) and the total amount of data (122) generated by a multiplex assay product. Under a fixed price scheme, if a customer only requires a few data points, then the cost per data point is high because the same price is paid independent of the number of data points required. This inverse relationship is illustrated by curve (120), which represents a function of the form, P_{f}=R₀/N, where R₀ is the fixed price (that typically includes the manufacturing cost plus mark-up) and N is the number of data points desired. Under a variable pricing scheme, a customer pays a minimal base price (that typically is at or near the manufacturing cost) plus additional fees monotonically related to the number of data points required. This is also an inverse relationship that is illustrated by curve (120), which represents a function of the form, Pᵥ=(AN+B)/N or Pᵥ=A+B/N, where A is a multiplier that reflects the price/data point and B is the base price. Typically, base price, B, is much less than fixed price, R₀. This has the effect of “pushing” curve (118) below curve (120), thereby reflecting a lower cost/data point for lower numbers of data points required, and making the multiplex assay product accessible to customers with lower budgets.

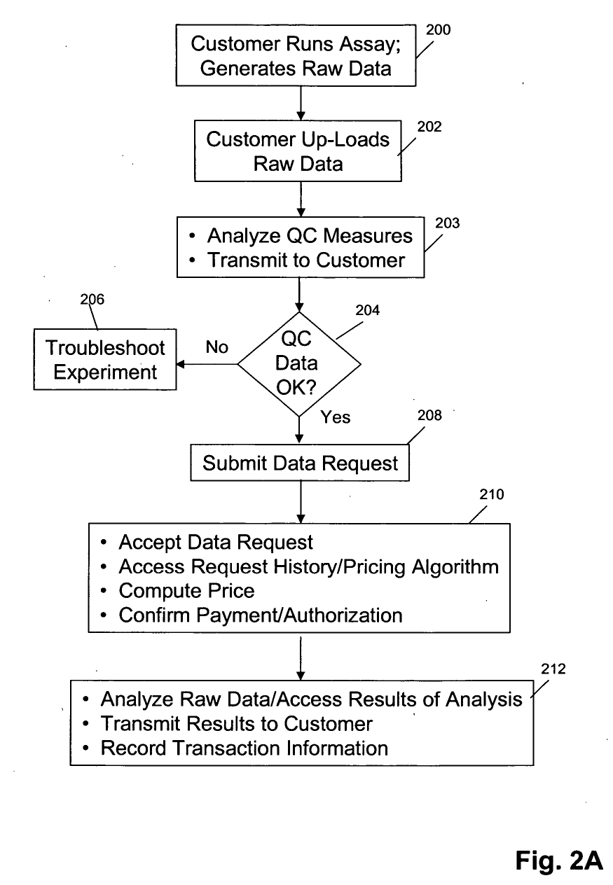

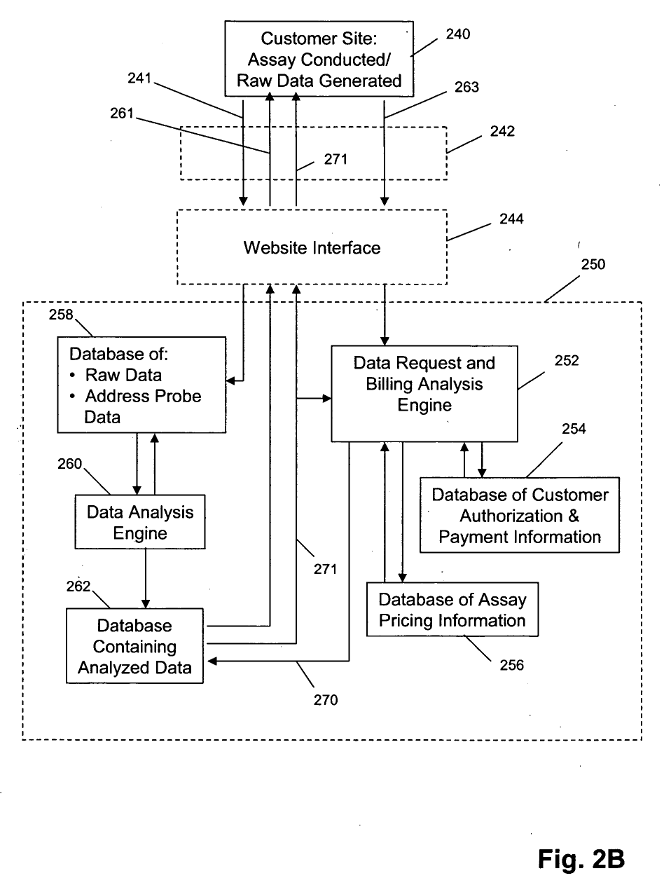

In accordance with one aspect of the invention, a customer may buy at a base price a multiplex assay product for use with or in an assay designed to detect or measure one or more properties of a large plurality of analytes, regardless of whether the customer desires information on all of the analytes or only a small subset of the analytes. In one aspect, the base price may be at or below the cost of manufacturing the multiplex assay product. The customer is then charged additional fees that relate to the amount of data extracted from the multiplex assay product. A general scheme of how such pricing is implemented is shown in FIG. 2A. As mentioned above, a customer purchases a multiplex assay kit and/or a multiplex assay product and performs an assay that generates raw data (200). The customer then transfers (202) the entire set of raw data to a data processing facility (250, FIG. 2B) where at least a quality control (QC) analysis (203) of the raw data is undertaken. Such quality control analysis may be carried out on the full set of raw data, or it may be a partial analysis based only on predetermined standards included with the kit purchase by customer. The result of the QC analysis is the generation of one or more numerical values that provide a measure of the quality of the data. Such measures may vary widely depending on the nature of the multiplex assay and its associated multiplex assay product. For example, in gene expression analysis or gene copy number analysis, a measure may be the coefficient of variation of signals generated from the hybridization of labeled control probes to replicate sites on a multiplex assay product. In genotyping analysis, a measure may be a “call rate,” or a percentage of total polymorphisms measured that generate signals that may be readily classified as homozygote or heterozygote. Typically, a multiplex assay product includes probe sites and/or corresponding probes that provide internal controls or standards for the quality of signals that are generated. After a QC measure is transmitted to the customer, the customer decides (204) whether or not to pay further fees for information based on analysis of the raw data. If the QC measure is below an acceptable value, then the customer may determine that the assay did not work correctly and requires troubleshooting or correction (206). Thus, no further costs connected with the multiplex assay product would be incurred by the customer. If the QC measure has an acceptable value, then the customer may obtain information on any portion or all of the analytes measured or detected in the assay by submitting (208) a request for data to the multiplex assay product vendor. In response, the vendor generates a price, or quote, for the customer for fulfilling the request. The price or quote may depend on several factors, including the nature of the analytes and/or probes for which information is sought, how much data has already been requested and delivered to the customer, and the like. In regard to the affect of the analyte or probe on price, in some instances, an antibody, nucleic acid target, or protein may be subject to royalty payments to a third party, in which case the vendor's cost may be passed on to the customer by way of a higher price for information related to such probes or targets, than for that related to probes or targets in the public domain. In regard to the affect of prior requests for date on price, in order to achieve marketing objectives, a vendor may establish a functional relationship between the information unit price and the cumulative amount of information obtained by the customer from the multiplex assay product. Such a functional relationship may be linear so that a customer receives a discount on the information unit price proportional to the total amount of information purchased. Alternatively, the functional relationship may be nonlinear so that a customer receives an increasing discount on the information unit price as the total amount of information purchased increases. Generally, the particular pricing scheme being applied is known to the customer at the time the multiplex assay product is purchased. Returning to FIG. 2A, data request (208) submitted by the customer, is received (210) by vendor computer system, which accesses databases providing (i) multiplex assay product identity, (ii) customer's request history related to the multiplex assay product, (iii) the pricing algorithm or scheme related to the multiplex assay product, and (iv) customer payment information, e.g. account balance, credit worthiness, etc. After such information is accessed, the computer system generates a price for the data request and confirms payment status, that is whether customer is credit worthy or has an account balance sufficient to cover the price of the data request. After confirmation that a customer is authorized to receive the requested data, raw data is processed (212) (if not previously done for the determination of the QC measures) to extract the data requested by the customer. Of course, in the course of such processing, all the data from every site of a multiplex assay product may be extracted at the same time. Such processing may include, but is not limited to, application of conventional data analysis techniques adapted to the particular multiplex assay product, such as global and/or local normalization of signal intensities; background signal corrections; filtering of various sorts, e.g. applying low intensity or high intensity cut-offs, optical filtering, etc.; analysis of variance; and the like. In addition, for certain kinds of multiplex assay products, such as expression arrays, such processing may also include application of clustering algorithms, pattern recognition algorithms, and the like. The following are exemplary references describing conventional data processing techniques that applicable to multiplex assay products: Kamberova and Shah, DNA Array Image Analysis: Nuts & Bolts (DNA Press, 2002); Draghici, Data Analysis Tools for DNA Microarrays (Chapman & Hall/CRC, 2003); and the like. After the requested data is processed, it is transmitted to the customer and the customer's records are updated with information about the transaction, e.g. type and amount of data requested.

The above transactions are readily implemented by electronic transfer of data and requests between a customer and a vendor via a computer network. In one aspect, such communications are carried out over an internet system, such as the World Wide Web, wherein a vendor website residing on a server computer provides a communication interface for customers. Internets or intranets, that is, communication networks connecting sets of computers, whether private or public, are well-know and their use and components are disclosed in many references, e.g. Kurose and Ross, Computer Networking (Addison Wesley, New York, 2001), and the like. A vendor computer system (250) for communicating with customers typically includes one or more server computers in a network of computers and databases, as illustrated in FIG. 2B. Such a system may exist at a single site or at multiple sites. At customer site (240), an assay employing a multiplex assay product is conducted so that raw data is generated. In one aspect, as part of a base price of the multiplex assay product, customer can access vendor website (244) over an internet connection (242). Through this connection customer transmits (241) raw data to the vendor, where it is automatically stored in database (258), which together with database (254) may constitute a customer database. The raw data is analyzed by data analysis program, or engine, (260) to produce a quality control measure, as described above. This analysis may be carried out without human intervention and automatically sent to the customer, or the analysis and QC measure may be queued for human review prior to transmission to the customer. The results of the analysis are stored in database (262), which may be the same or different than database (258). After the QC measure is transmitted (261) to the customer, the customer determines whether or not to request data. If the QC measure is satisfactory, the customer may request (263) some portion or all of the analyzed data by electronically sending the vendor a request for analyzed data that contains appropriate identifying information, which typically includes an amount (e.g., a number of data points) and a content (e.g., names of analytes for which data is requested). Such identifying information typically is a list of one or more analytes for which the multiplex assay product contains probes. Such request is accepted by a data request and billing analysis engine (252) which accesses customer and product databases to carry out conventional checks, e.g. making sure the analyte requested corresponds to a probe on the multiplex assay product, and confirms that the customer has appropriate authorization to receive the requested data. Usually, such authorization is related to the customer's capacity to pay for the requested information, but it may also relate to whether the customer has a license to access data related to a proprietary analyte or probe for such analyte. Data request and billing analysis engine (252) accesses database (254) containing customer authorization and payment information (i) to confirm that the customer request can be fulfilled and (ii) to determine the customer's data request history for determining the price of the current request (for example, if the pricing function provides discounts based on the total amount of data requested from a specific or a family of multiplex assay products). Data request and billing analysis engine (252) also computes an incremental price for the request for data by accessing database (256) that contains a pricing algorithm or function for the multiplex assay product being used by the customer. The pricing algorithm and data (256) may include a wide variety of pricing schemes, as exemplified in Table I. Preferably, a pricing algorithm for cumulative purchases of data points is any monotonic function of data point number.

TABLE I
Exemplary Pricing Schemes

| Pricing Scheme | Algorithm |
|---|---|
| Uniform linear | AN for any N = N₁, N₂, . . . |
| | after payment of base price, B. |
| Linear plus special | AN for any N = N₁, N₂, . . . , |
| | except Nᵢ = pᵢ, Nⱼ = pⱼ, . . . |
| | for proprietary data points, and |
| | after payment of base price, B. |
| Linear with successive | A₁N, for any N = N₁, N₂, . . . |
| discounts | to Nk, after payment of base price B, |
| | A₂N, for any N = N_{k + 1}, N_{k + 2}, . . . |
| | Nm, where A₂ < A₁, |
| | A₃N, for any N = N_{m + 1}, N_{m + 2}, . . . |
| | Nr, where A₃ < A₂, etc. |
| Continuously discounted | f(N) = (N)^{1/2} for any N = N₁, N₂, . . . |
| | after payment of base price, B. |

After these functions are performed, data request and billing analysis engine (252) generates commands (270) for transmission of the requested data (271) from database (262) to customer. Website interface (244), data analysis engine (260), and data request and billing analysis engine (252) are computer programs written in conventional languages for performing the indicated functions and may be embodied in computer-readable products, such as CDs, or the like.

In one aspect, the system and method of the invention, such as that described above, allows pricing schemes that extend over multiple products, as illustrated in FIG. IF. Curve (170) showing price per data point can represent a function of data points from more than one product, thereby giving a customer an incentive to continue purchases of a multiplex assay product from the same vendor. Under such as scheme, a customer request for data can include a number of data points greater than the multiplex level of a single multiplex assay product.

### Exemplary Multiplex Assay Product

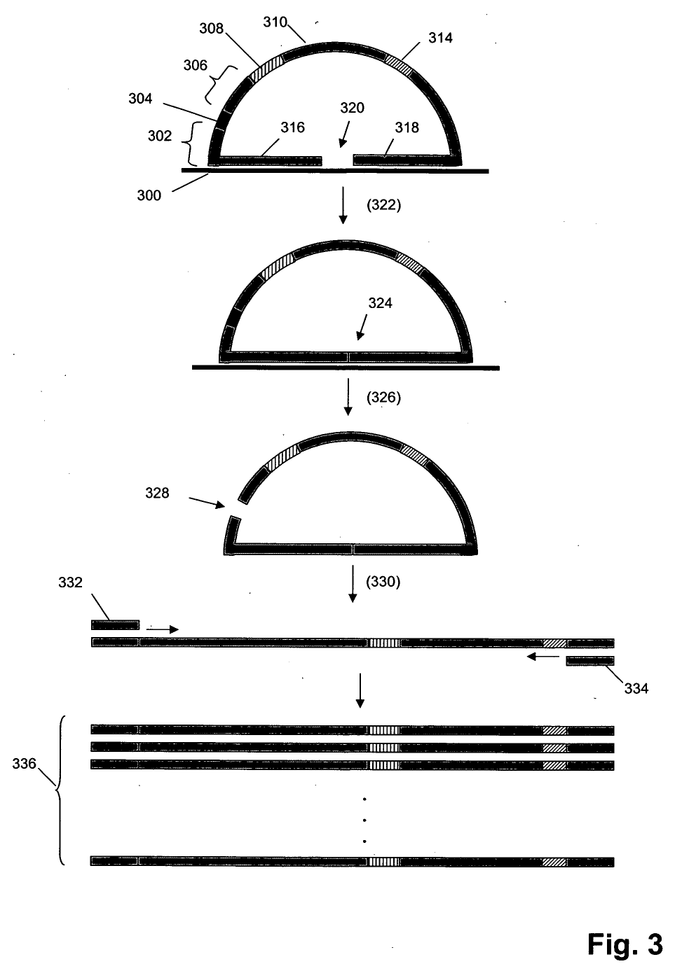

Molecular inversion probes used in conjunction with an array of tag complements is an example of an assay using a multiplex assay product that may be priced in accordance with the invention. Such assay systems and their use with arrays of tag complements are disclosed in Hardenbol et al, Nature Biotechnology, 21: 673-678 (2003); and Willis et al, U.S. Pat. No. 6,858,412; which are incorporated by reference. FIG. 3 illustrates a molecular inversion probe and how it can be used to generate an amplicon after interacting with a target polynucleotide in a sample. A linear version of the probe is combined with a sample containing target polynucleotide (300) under conditions that permit target-specific region 1 (316) and target-specific region 2 (318) to form stable duplexes with complementary regions of target polynucleotide (300). The ends of the target-specific regions may abut one another (being separated by a “nick”) or there may be a gap (320) of several (e.g. 1-10 nucleotides) between them. In either case, after hybridization of the target-specific regions, the ends of the two target specific regions are covalently linked by way of a ligation reaction or an extension reaction followed by a ligation reaction, i.e. a so-called “gap-filling” reaction. The latter reaction is carried out by extending with a DNA polymerase a free 3′ end of one of the target-specific regions so that the extended end abuts the end of the other target-specific region, which has a 5′ phosphate, or like group, to permit ligation. In one aspect, a molecular inversion probe has a structure as illustrated in FIG. 3. Besides target-specific regions (316 and 318), in sequence such a probe may include first primer binding site (302), cleavage site (304), second primer binding site (306), first tag-adjacent sequences (308) (usually restriction endonuclease sites and/or primer binding sites) for tailoring one end of a labeled target sequence containing oligonucleotide tag (310), and second tag-adjacent sequences (314) for tailoring the other end of a labeled target sequence. Alternatively, cleavage-site (304) may be added at a later step by amplification using a primer containing such a cleavage site. In operation, after specific hybridization of the target-specific regions and their ligation (322), the reaction mixture is treated with a single stranded exonuclease that preferentially digests all single stranded nucleic acids, except circularized probes. After such treatment, circularized probes are treated (326) with a cleaving agent that cleaves the probe between primer (302) and primer (306) so that the structure is linearized (330). Cleavage site (304) and its corresponding cleaving agent is a design choice for one of ordinary skill in the art. In one aspect, cleavage site (304) is a segment containing a sequence of uracil-containing nucleotides and the cleavage agent is treatment with uracil-DNA glycosylase followed by heating. After the circularized probes are opened, the linear product is amplified, e.g. by PCR using primers (332) and (334), to form amplicons (336). A multiplexed readout may be obtained from amplicon (336) by labeling and excising oligonucleotide tag (310) and specifically hybridizing the labeled tags to a microarray of tag complements, e.g. a GenFlex array (Affymetrix, Santa Clara, Calif.); a bead array (Illumina, San Diego, Calif.); or a fluid array, e.g. Chandler et al, U.S. Pat. No. 5,981,180 (Lumenix, Austin, Tex.). Oligonucleotide tags suitable for use in multiplex assay products are disclosed in Brenner et al, U.S. Pat. No. 5,846,719; Mao et al (cited above); Fan et al, International patent publication WO 2000/058516; Morris et al, U.S. Pat. No. 6,458,530; Morris et al, U.S. patent publication 2003/0104436; Church et al, European patent publication 0 303 459; Huang et al, U.S. Pat. No. 6,709,816; which references are incorporated herein by reference.

Methods for hybridizing labeled target sequences to microarrays, and like platforms, suitable for the present invention are well known in the art. Guidance for selecting conditions and materials for applying labeled target sequences to solid phase supports, such as microarrays, may be found in the literature, e.g. Wetmur, Crit. Rev. Biochem. Mol. Biol., 26: 227-259 (1991); DeRisi et al, Science, 278: 680-686 (1997); Chee et al, Science, 274: 610-614 (1996); Duggan et al, Nature Genetics, 21: 10-14 (1999); Schena, Editor, Microarrays: A Practical Approach (IRL Press, Washington, 2000); Freeman et al, Biotechniques, 29: 1042-1055 (2000); and like references. Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference. Hybridization conditions typically include salt concentrations of less than about 1 M, more usually less than about 500 mM and less than about 200 mM. Hybridization temperatures can be as low as 5° C., but are typically greater than 22° C., more typically greater than about 30° C., and preferably in excess of about 37° C. Hybridizations are usually performed under stringent conditions, i.e. conditions under which a probe will stably hybridize to a perfectly complementary target sequence, but will not stably hybridize to sequences that have one or more mismatches. The stringency of hybridization conditions depends on several factors, such as probe sequence, probe length, temperature, salt concentration, concentration of organic solvents, such as formamide, and the like. How such factors are selected is usually a matter of design choice to one of ordinary skill in the art for any particular embodiment. Usually, stringent conditions are selected to be about 5° C. lower than the Tₘ for the specific sequence for particular ionic strength and pH. Exemplary hybridization conditions include salt concentration of at least 0.01 M to no more than 1 M Na ion concentration (or other salts) at a pH 7.0 to 8.3 and a temperature of at least 25° C. Additional exemplary hybridization conditions include the following: 5×SSPE (750 mM NaCl, 50 mM sodium phosphate, 5 mM EDTA, pH 7.4).

Exemplary hybridization procedures for applying labeled target sequence to a GenFlex™ microarray (Affymetrix, Santa Clara, Calif.) is as follows: denatured labeled target sequence at 95-100° C. for 10 minutes and snap cool on ice for 2-5 minutes. The microarray is pre-hybridized with 6×SSPE-T (0.9 M NaCl 60 mM NaH₂,PO₄, 6 mM EDTA (pH 7.4), 0.005% Triton X-100)+0.5 mg/ml of BSA for a few minutes, then hybridized with 120 μL hybridization solution (as described below) at 42° C. for 2 hours on a rotisserie, at 40 RPM. Hybridization Solution consists of 3M TMACL (Tetramethylammonium. Chloride), 50 mM MES ((2-[N-Morpholino]ethanesulfonic acid) Sodium Salt) (pH 6.7), 0.01% of Triton X-100, 0.1 mg/ml of Herring Sperm DNA, optionally 50 pM of fluorescein-labeled control oligonucleotide, 0.5 mg/ml of BSA (Sigma) and labeled target sequences in a total reaction volume of about 120 μL. The microarray is rinsed twice with 1×SSPE-T for about 10 seconds at room temperature, then washed with 1×SSPE-T for 15-20 minutes at 40° C. on a rotisserie, at 40 RPM. The microarray is then washed 10 times with 6×SSPE-T at 22° C. on a fluidic station (e.g. model FS400, Affymetrix, Santa Clara, Calif.). Further processing steps may be required depending on the nature of the label(s) employed, e.g. direct or indirect. Microarrays containing labeled target sequences may be scanned on a confocal scanner (such as available commercially from Affymetrix) with a resolution of 60-70 pixels per feature and filters and other settings as appropriate for the labels employed. GeneChip Software (Affymetrix) may be used to convert the image files into digitized files for further data analysis.

The above teachings are intended to illustrate the invention and do not by their details limit the scope of the claims of the invention. While preferred illustrative embodiments of the present invention are described, it will be apparent to one skilled in the art that various changes and modifications may be made therein without departing from the invention, and it is intended in the appended claims to cover all such changes and modifications that fall within the true spirit and scope of the invention.

We claim:

1. A system for pricing one or more multiplex assay products each having a plurality of probe sites for generating signals related to one or more analytes, the system comprising:
at least one multiplex assay product provided to a customer for a base price;
a customer database containing (i) raw data transmitted by the customer and generated by performing an assay with the multiplex assay product, and (ii) customer authorization information that indicates whether customer has paid fees associated with accessing analyzed data set forth in the request for data and customer payment information that indicates a history of payments associated with each multiplex assay product;
a product database containing (i) probe address data for each multiplex assay product, the probe address data including information that associates each of the one or more analytes with an address of a probe site on the multiplex assay product of the customer, and (ii) a pricing algorithm for each multiplex assay product;
a data analysis engine that converts raw data into analyzed data;
a request for data by a customer to obtain analyzed data, the request for data having an amount and a content; and
a billing analysis engine receiving the request for data, accessing the customer database storing probe address data for the customer's multiplex assay product and customer authorization information, validating that customer is authorized to receive requested analyzed data, and transmitting to customer requested analyzed data.

2. The system of claim 1 wherein said multiplex assay product has a cost of manufacturing and wherein the base price is substantially equivalent to the cost of manufacturing said multiplex assay product.

3. The system of claim 2 wherein said multiplex assay product is a microarray.

4. The system of claim 3 wherein said microarray has from 1000 to 10,000 probe sites.

5. The system of claim 3 wherein said microarray has from 10,000 to 100,000 probe sites.

6. The system of claim 3 wherein said microarray has from 10,000 to 1,000,000 probe sites.

7. The system of claim 3 wherein said microarray has from 10,000 to 5,000,000 probe sites.

8. The system of claim 3 wherein said microarray has from 10,000 to 50,000,000 probe sites.

9. A method of providing a customer with data points generated by one or more multiplex assay products, the method comprising the steps of:
selling at least one multiplex assay product by a vendor to a customer for a base price;
transmitting to the customer a quality control measure in response to the customer (i) performing a multiplex assay that uses the multiplex assay product, and (ii) transmitting raw data from the multiplex assay product to the vendor;
receiving from the customer a request for data if the quality control measure satisfies a predetermined criterion of the customer, the request for data indicating a content and an amount of data;
generating a price for the request for data, the price being a monotonic function of the content and the amount of data;
validating that customer is authorized to receive data; and
transmitting data to the customer.

10. The method of claim 9 wherein said multiplex assay product has a cost of manufacturing and wherein the base price is substantially equivalent to the cost of manufacturing said multiplex assay product.

11. The method of claim 10 wherein said multiplex assay product is a microarray.

12. The method of claim 11 wherein said microarray has from 1000 to 10,000 probe sites.

13. The method of claim 11 wherein said microarray has from 10,000 to 100,000 probe sites.

14. The method of claim 11 wherein said microarray has from 10,000 to 1,000,000 probe sites.

15. The method of claim 11 wherein said microarray has from 10,000 to 5,000,000 probe sites.

16. The method of claim 11 wherein said microarray has from 10,000 to 50,000,000 probe sites.
